(19) United States
(12) Patent Application Publication
(10) Pub. No.: US 2007/0226312 A1
(43) Pub. Date: Sep. 27, 2007

(54) System and method for using web syndication feeds as a change log for synchronization in a UPnP audio/video environment

(75) Inventors: Vlad Stirbu, Tampere (FI); Petros Belimpasakis, Tampere (FI)

Correspondence Address: FOLEY & LARDNER LLP, P.O. BOX 80278, SAN DIEGO, CA, 92138-0278, US

(73) Assignee: Nokia Corporation

(21) Appl. No.: 11/389,637

(22) Filed: Mar. 24, 2006

(51) Int. Cl. G06F 15/16

(52) U.S. Cl. 709/217

(57) ABSTRACT

The use of ATOM/RSS feeds as a change log for web syndication. According to the present invention, whenever the SystemUpdateID changes, the CDS logs the change as a new entry in the ATOM feed. The SystemUpdateID is checked by a control point whenever it joins the network. If the SystemUpdateID is different, the control point promptly fetches the log, thereby eliminating the need to browse the entire CDS. When all of the items have been synchronized, the control point updates the time of last synchronization to reflect the current time. The control point then invokes other UPnP methods as necessary or desired.

### FIELD OF THE INVENTION

The present invention relates generally to web syndication. More particularly, the present invention relates to the updating of web syndication content at various control points.

### BACKGROUND OF THE INVENTION

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Web syndication is a form of syndication in which information from a website is made available for use by other sites or clients. “Web syndication” commonly refers to making Web feeds available from a site so that other visitors can get an updated list of content from it. For example, with web syndication a user can obtain an updated list of a person's blog postings using web syndication. Web syndication originated with news and blog sites, but it is increasingly being used to syndicate virtually any type of information.

Universal Plug and Play (UPnP) technology defines an architecture for pervasive peer-to-peer network connectivity of intelligent appliances, wireless devices, and personal computers of all types. UPnP technology is designed to bring easy-to-use, flexible, standards-based connectivity to ad-hoc or unmanaged networks whether in the home, in a small business, public locations, or systems connected to the Internet. UPnP technology provides a distributed, open networking architecture that leverages TCP/IP and web technologies to enable seamless proximity networking, in addition to providing control and data transfer among networked devices. The UPnP audio/video transport defines how media devices such as servers, renderers and control points can communication with each other for the distribution and consumption of content.

Content directory service (CDS) metadata typically includes two variables of interest to web syndication and the present invention. The CDS, which is defined as part of the UPnP AV architecture, provides a set of functionalities which allow UPnP control points to access the content stored on media servers. A SystemUpdateID variable is defined in CDS v. 1.0 and 2.0. This required variable changes whenever anything in the Content Directory changes. A change could comprise, for example, a new or removed object, or a change in the metadata of an object. The actual value of the SystemUpdateID variable is unspecified. When using the SystemUpdateID variable, clients should only check for equality with previous values of SystemUpdateID.

A ContainerUpdateID variable is an optional state variable. This variable is an unordered comma separated value (CSV) list of ordered pairs. Each pair comprises a ContainerID and a ContainerUpdateID, in that order. Each time a container is modified, its ContainerUpdateID is incremented and the ordered pair of the ContainerID and the ContainerUpdateID are concatenated to the list of ContainerUpdateIDs. The ContainerUpdateID is a moderated and evented state variable and is only used for eventing; it does not comprise a history list of container changes. Home devices can make use of the existing evented variables (e.g., SystemUpdateID and ContainerUpdateIDs) and actions (e.g., browse or search) to perform a basic synchronization.

The consumption of media in UPnP AV environments can be quite slow due to the fact that a control point needs to search or browse the CDS metadata each time before the content can be played/rendered. The browse and search actions involve usually heavy network traffic. As a result, latencies can be observed at the user interface level, making the overall usability relatively poor. This situation can be improved by caching the CDS metadata in the control point, thus eliminating the need to perform the search and browse operations on the CDS. In this situation, each time the SystemUpdateID (and implicitly the ContainerUpdateID) changes, the control point will fetch the metadata pointed to by ContainerID and cache it locally, allowing the metadata cache to be in sync with the CDS metadata.

In a typical UPnP environment, there might be several control points interacting with a single media server, and these control points can have interactions with the CDS metadata by adding, updating or deleting media items. A sample environment is depicted in FIG. 1, where a pair of connected control points 100 and a media server 110 are connected to a home network 120. However, UPnP AV services do not have the necessary features to enable a control point to synchronize the CDS metadata when such a change occurs. Therefore, and in practice, the caching of metadata is not very useful if mechanisms to keep the metadata synchronized are not available.

The situation described above is particularly problematic for mobile UPnP devices such as mobile phones which, by their nature, regularly leave and join the home UPnP network. The UPnP AV does not have any provisions to help disconnected devices (depicted at 130 in FIG. 1), such as mobile telephones, overcome this dilemma, as change notifications are available only to devices which are turned on with regard to UPnP and have active subscriptions on media servers. Additionally, problems arise with this approach because the ContainerUpdateID variable is only an optional variable. Still further, although the disconnected control point can detect that the CDS has changed by invoking a GetSystemUpdateID message and comparing the response with the last known message, but after this step it still has to browse the entire CDS to determine what has changed. This both consumes resources and is quite slow.

It would therefore be desirable to develop an improved system for updating CDS logs in UPnP environments.

### SUMMARY OF THE INVENTION

The present invention involves the use of ATOM/really simple syndication (RSS) feeds as a change log for web syndication. According to the present invention, whenever the SystemUpdateID changes, the CDS logs the change as a new entry in the ATOM feed. The SystemUpdateID is checked by a control point whenever it joins the network. If the SystemUpdateID is different, the control point will promptly fetch the log (e.g., the ATOM feed), thereby eliminating the need to browse the entire CDS. Therefore, even though the entries in the ATOM feed are basically deltas of the changed metadata and may not have any meaning by themselves, they are used in the context of a synchronization application.

One embodiment of the present invention comprises a method, computer program product, and device for synchronizing a content directory service log on a UPnP AV server at a control point, comprising transmitting a HTTP GET request of a log feed to the UPnP AV server; receiving an ATOM feed including a predetermined number of most recent updates of the content directory service log; and updating a cache of the control point with updates from the ATOM feed as necessary. It is then determined if the oldest update in the ATOM feed is more recent than the time that the last synchronization occurred at the control point. If the oldest update in the feed is more recent than the time that the last synchronization occurred at the control point, a next ATOM feed of updates is retrieved. Subsequent ATOM feeds of updates are retrieved until synchronization is complete at the control point, after which a value indicative of a last synchronization time is updated.

Another embodiment of the present invention comprises a method, computer program product, and device for aiding a UPnP control point in synchronizing a content directory service log, comprising receiving a HTTP GET request of a log feed from the UPnP control point and transmitting an ATOM feed including a predetermined number of most recent updates of the content directory service log. After the UPnP control point has updated a cache of the control point with updates from the ATOM feed as necessary and determined that the oldest update in the ATOM feed is more recent than the time that the last synchronization occurred at the control point, a next ATOM feed of updates is transmitted. Subsequent ATOM feeds of updates are transmitted until synchronization is complete at the control point.

A further embodiment of the present invention comprises a system for synchronizing a content directory service log, comprising a UPnP control point and a UPnP AV server in at least selective communication with the UPnP control point. The UPnP control point is configured to transmit a HTTP GET request of a log feed to the UPnP AV server; receive an ATOM feed including a predetermined number of most recent updates of a content directory service log; and update a cache of the control point with updates from the ATOM feed as necessary. The UPnP control point is also configured to determine if the oldest update in the ATOM feed is more recent than the time that the last synchronization occurred at the control point. If the oldest update in the feed is more recent than the time that the last synchronization occurred at the control point, the UPnP control point retrieves a next ATOM feed of updates. Subsequent ATOM feeds of updates are retrieved until synchronization is complete at the control point, at which time the UPnP control point updates a value indicative of the last synchronization time.

The present invention possesses several notable advantages over conventional systems. With the present invention, the synchronization logic is implemented in the client device. Implementers can choose to implement the logic and decide whether to have advanced functionality or not, while keeping the device simple in nature. With the present invention, a client/control point manufacturer can use the synchronization logic as a product differentiator. Additionally, the server is stateless with regard to the control points with the present invention. The log is the same for all clients; they decide when to stop the synchronization process. Therefore, the server remains a simple device. Furthermore, synchronization can also be performed with non-UPnP devices. The present invention can also be easily implemented because ATOM is based on HTTP, and the HTTP stack already exists in UPnP devices. There is therefore no need for new components. With the present invention, a control point can even synchronize remotely, since the ATOM feed can be easily accessed for external networks. Lastly, change logs embodied as ATOM feeds can also be used in non-UPnP environments. The present invention can be incorporated into a wide variety of Digital Living Network Alliance (DLNA)-compliant products and can also be used by virtually any device that needs to synchronize CDS metadata on at least an occasional basis.

These and other advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is a representation of a UPnP operating environment showing a media server, a plurality of connected control points, and a disconnected control point;

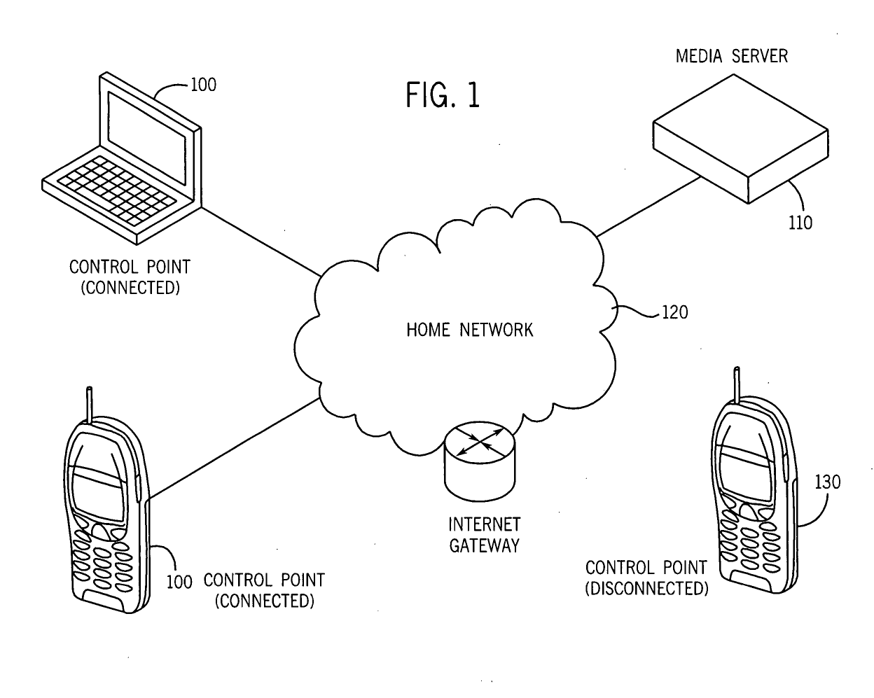

FIG. 2 is a flow chart showing the interaction between a control point, an ATOM server, and a UPnP CDS according to one embodiment of the present invention;

FIG. 3 is a perspective view of a mobile telephone that can be used in the implementation of the present invention; and

FIG. 4 is a schematic representation of the telephone circuitry of the mobile telephone of FIG. 3.

### DETAILED DESCRIPTION OF THE PREFERRED EMBODIMENTS

The present invention involves the use of ATOM/really simple syndication (RSS) feeds as a change log for web syndication. According to the present invention, whenever the SystemUpdateID changes, the CDS logs the change as a new entry in the ATOM feed. The SystemUpdateID is checked by a control point whenever it joins the network. If the SystemUpdateID is different, the control point will promptly fetch the log (e.g., the ATOM feed), thereby eliminating the need to browse the entire CDS. Therefore, even though the entries in the ATOM feed are basically deltas of the changed metadata and may not have any meaning by themselves, they are used in the context of a synchronization application.

ATOM is an XML-based document format that is often used for the syndication of web content, as well as an HTTP-based protocol for editing weblogs based on the format. ATOM is a newer and more advanced protocol than RSS. Apart from the basic web syndication and feeds that are also provided by RSS, ATOM supports more standardized meta-data information, along with the ability to make posts from an ATOM client to an ATOM server. This is in contrast to RSS, which only allows the client to obtain information from a server and not to post information.

One advantage to using ATOM as a CDS log is that the CDS already possesses the functionality of detecting when the metadata is changing. According to the present invention, whenever the SystemUpdateID changes, the CDS logs the change as a new entry in the ATOM feed. When implementing the present invention, the URL to the ATOM feed should be included in the description document of the media server/CDS being used. It is up to the media server implementation to decide when log entries should be removed.

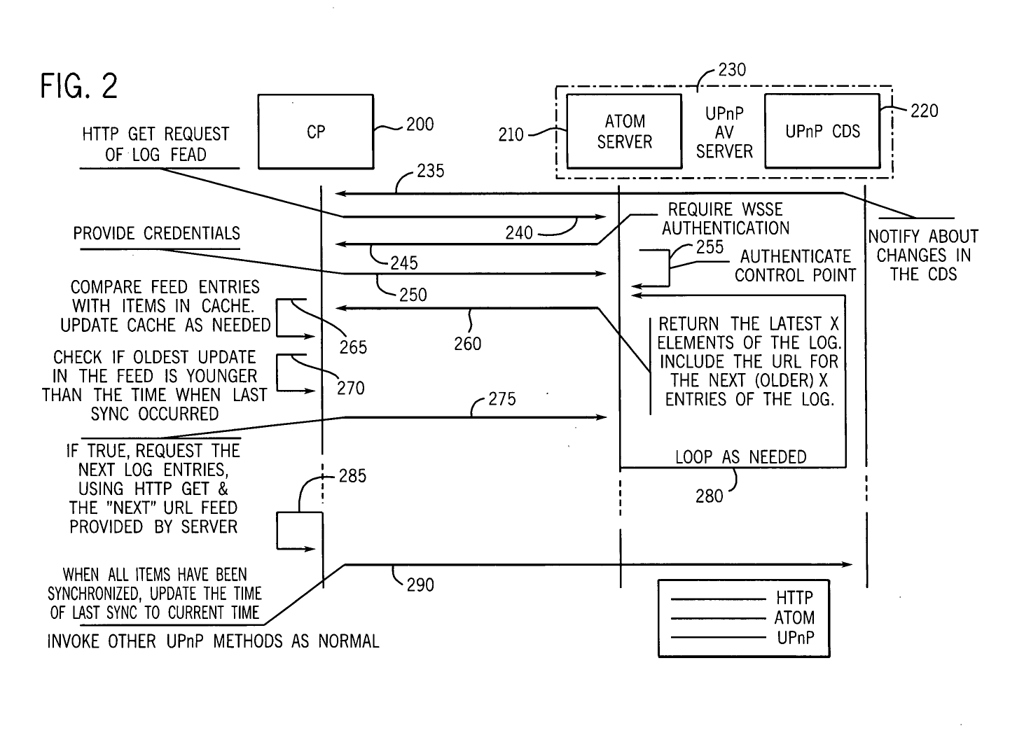

FIG. 2 shows the sequence of actions that occur among a control point 200, an ATOM server 210 and a UPnP CDS 220 during the synchronization process according to one embodiment of the present invention. As depicted in FIG. 2, the UPnP CDS 220 and the ATOM server 210 are both part of a UPnP AV server 230. At 235 in FIG. 2, the UPnP CDS 220 transmits a UPnP message to the control point 200, notifying the control point 200 about changes in the UPnP CDS 220. At this point, the control point 200 receives a URL (e.g., http://10.0.0.1/atom/) that provides the list of latest CDS changes, in ATOM syndication format, from the UPnP AV server 230. As discussed previously, the UPnP AV server 230 notifies all subscribed control points 200 of any changes.

In response to the receipt of this notification, at 240 the control point 200 transmits an HTTP GET request of the log feed to the ATOM server 210. At 245, the ATOM server 210 responds with an HTTP messaging requiring WSSE authorization (WSSE is a family of open security specifications for web services). The control point 200 therefore provides its credentials for authentication at 250 in a HTTP message. The credentials can be derived, for example, from UPnP security keys. If the control point 200 is authenticated (which occurs at 255), then the ATOM server 210 transmits the latest x elements of the log in an ATOM feed to the control point 200 at 260. This feed includes the next (older) x entries of the log in ATOM syndication format. x refers to a value which is dependent upon the implementation of the UPnP AV server 230. The feed also includes a URL (e.g., http://10.0.0.1/atom/2) to the next x changes that exist in the log, using the “Collection Paging”, as specified in the ATOM publishing protocol.

At 265, the control point 200 receives and parses the ATOM feed. From a “atom:updated” field of each entry in the field, the control point 200 identifies when each item was last updated. Comparing it with the time that last sync occurred, the control point decides if the cache needs to be updated with the metadata included in the feed. If necessary, the cache is updated.

At 270, the control point 200 checks whether the oldest update in the feed is younger (newer) than the time that the last synchronization occurred. If the oldest update in the feed is younger (newer) than the time that the last synchronization occurred, then the control point 200 requests the next log entries at 275, using a HTTP GET message and the “next” URL feed provided by the ATOM server 210. Subsequent feeds (e.g., http://10.0.0.1/atom/2, http://10.0.0.1/atom/3, etc.) are then provided as represented by a feedback loop 280. When all of the items have been synchronized (i.e., when the oldest update in the feed is not younger (newer) than the time that the last synchronization occurred), the control point 200 updates the time of last synchronization to reflect the current time at 285. The control point 200 then invokes other UPnP methods at 290 as is known in the art. This is accomplished as if the control point 200 had browsed the UPnP CDS 220 using UPnP CDS functions according to conventional methods.

The following is a full example of the computer code use to implement one embodiment of the present invention:

<?xml version=“1.0” encoding=“utf-8”?>

<feed xmlns=“http://www.w3.org/2005/Atom”>

<link rel=“first” href=“http://10.0.0.1/atom/” />
<link rel=“next” href=“http://10.0.0.1/atom/2” />
<link rel=“last” href=“http://10.0.0.1/atom/10” />

<title>My UPnP CDS updates</title>
<link href=“http://10.0.0.1/”/>
<updated>2006-02-13T18:30:02Z</updated>
<author>

<name>My name</name>

</author>
<id>urn:uuid:60a76c80-d399-11d9-b93C-0003939e0af6</id>
<entry>

<title>Concert Picture</title>
<content type=“image/jpeg”
src=“http://10.0.0.1/2006/02/13/concert.jpg”/>
<id>urn:uuid:1225c695-cfb8-4ebb-aaaa-80da344efa6a</id>
<updated>2006-02-13T18:30:02Z</updated>
<summary>Some text.</summary>

</entry>
<entry>

<title>Holiday on boat</title>
<content type=“image/jpeg”
src=“http://10.0.0.2/2005/08/11/holiday.jpg”/>
<id>urn:uuid:1225c695-cfb8-4ebb-aaaa-80da31234356</id>
<updated>2006-02-13T17:44:00Z</updated>
<summary>Some other text.</summary>

</entry>

</feed>

In the above code, the following lines of texts comprise “collection paging” links:

<link rel=“first” href=“http://10.0.0.1/atom/” />
<link rel=“next” href=“http://10.0.0.1/atom/2” />
<link rel=“last” href=“http://10.0.0.1/atom/10” />

The line <title>My UPnP CDS updates</title> is the feed title. The line <updated>2006-02-13T18:30:02Z</updated> indicates the time that the feed was last updated. Each code group beginning with <entry> and ending with </entry> indicates an entry. Of this code, the code line beginning with <content> represents the link to content. This code has many alternative representations and are known to those skilled in the art. The code line beginning with <id> is the unique ID of the entry. The code line beginning with <updated> indicates the time that the entry was last modified. The code line beginning with <summary> comprises metadata.

It should be noted that the ATOM feed or other web syndication feed discussed herein can be used as a change log in other environments where lightweight metadata synchronization is needed (one way synchronization). Additionally, it should also be noted that the UPnP AV environment is just one example where the present invention can be implemented. In fact, the present invention can implemented in non-AV environments as well.

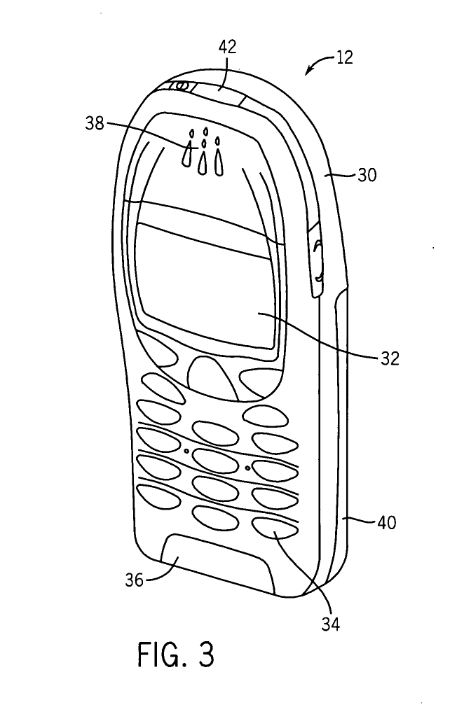

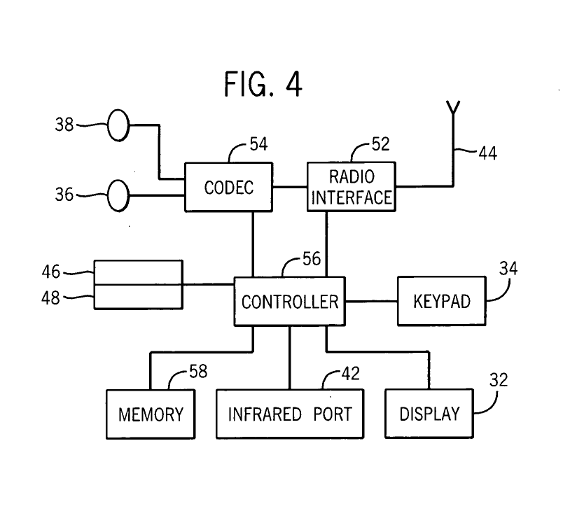

FIGS. 3 and 4 show one representative mobile telephone 12 which can be used as a control point 200 within the present invention. It should be understood, however, that the present invention is not intended to be limited to one particular type of mobile telephone 12 or other electronic device. Additionally, it should be understood that several of the features of the mobile telephone 12 of FIGS. 3 and 4 can also be incorporated into other electronic devices of the present invention, including the UPnP AV server 230.

The mobile telephone 12 of FIGS. 3 and 4 includes a housing 30, a display 32 in the form of a liquid crystal display, a keypad 34, a microphone 36, an ear-piece 38, a battery 40, an infrared port 42, an antenna 44, a smart card 46 in the form of a UICC according to one embodiment of the invention, a card reader 48, radio interface circuitry 52, codec circuitry 54, a controller 56 and a memory 58. Individual circuits and elements are all of a type well known in the art, for example in the Nokia range of mobile telephones.

Communication devices of the present invention may communicate using various transmission technologies including, but not limited to, Code Division Multiple Access (CDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, etc. A communication device may communicate using various media including, but not limited to, radio, infrared, laser, cable connection, and the like.

The present invention is described in the general context of method steps, which may be implemented in one embodiment by a program product including computer-executable instructions, such as program code, executed by computers in networked environments. Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represent examples of corresponding acts for implementing the functions described in such steps.

Software and web implementations of the present invention could be accomplished with standard programming techniques with rule based logic and other logic to accomplish the various database searching steps, correlation steps, comparison steps and decision steps. It should also be noted that the words “component” and “module,” as used herein and in the claims, is intended to encompass implementations using one or more lines of software code, and/or hardware implementations, and/or equipment for receiving manual inputs.

The foregoing description of embodiments of the present invention have been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments and with various modifications as are suited to the particular use contemplated.

What is claimed is:

1. A method for synchronizing content directory service metadata on a UPnP server at a control point, comprising:
transmitting a HTTP GET request of a log feed to the UPnP server;
receiving a web syndication feed including a predetermined number of most recent updates of the content directory service log;
updating a cache of the control point with updates from the web syndication feed as necessary;
determining if the oldest update in the web syndication feed is more recent than the time that the last synchronization occurred at the control point;
if the oldest update in the feed is more recent than the time that the last synchronization occurred at the control point, retrieving a next web syndication feed of updates;
continuing to retrieve subsequent web syndication feeds of updates until synchronization is complete at the control point; and
updating a value indicative of a last synchronization time.

2. The method of claim 1, further comprising, before receiving the web syndication feed:
receiving a request for authentication from the UPnP server; and
in response to the request, providing credentials to the UPnP server for authentication.

3. The method of claim 1, wherein the HTTP GET request is transmitted in response to a notification of changes in the content directory service received from the UPnP server.

4. The method of claim 1, further comprising, after updating the value indicative of the last synchronization time, invoking at least one UPnP method to the UPnP server.

5. The method of claim 1, wherein the web syndication feed is received from an web syndication server formed as part of the UPnP server.

6. The method of claim 1, wherein the web syndication feed includes a URL to the predetermined number of most recent updates of the content directory service log.

7. The method of claim 1, wherein the UPnP server comprises a UPnP AV server.

8. The method of claim 1, wherein the web syndication feed comprises an ATOM feed.

9. A computer program product, embodied in a computer readable medium, for synchronizing content directory service metadata on a UPnP server at a control point, comprising:
computer code for transmitting a HTTP GET request of a log feed to the UPnP server;
computer code for receiving an web syndication feed including a predetermined number of most recent updates of the content directory service log;
computer code for updating a cache of the control point with updates from the web syndication feed as necessary;
computer code for determining if the oldest update in the web syndication feed is more recent than the time that the last synchronization occurred at the control point;
computer code for if the oldest update in the feed is more recent than the time that the last synchronization occurred at the control point, retrieving a next web syndication feed of updates;
computer code for continuing to retrieve subsequent web syndication feeds of updates until synchronization is complete at the control point; and
computer code for updating a value indicative of a last synchronization time.

10. The computer program product of claim 9, further comprising:
computer code for, before receiving the web syndication feed, receiving a request for authentication from the UPnP server; and
computer code for, in response to the request, providing credentials to the UPnP server for authentication.

11. The computer program product of claim 9, wherein the HTTP GET request is transmitted in response to a notification of changes in the content directory service received from the UPnP server.

12. The computer program product of claim 9, further comprising computer code for, after updating the value indicative of the last synchronization time, invoking at least one UPnP method to the UPnP server.

13. The computer program product of claim 9, wherein the web syndication feed is received from an web syndication server formed as part of the UPnP server.

14. The computer program product of claim 9, wherein the web syndication feed includes a URL to the predetermined number of most recent updates of the content directory service log.

15. The computer program product of claim 9, wherein the UPnP server comprises a UPnP AV server.

16. The computer program product of claim 9, wherein the web syndication feed comprises an ATOM feed.

17. A UPnP control point, comprising:
a processor; and
a memory unit communicatively connected to the processor and including:
computer code for transmitting a HTTP GET request of a log feed to a UPnP server;
computer code for receiving an web syndication feed including a predetermined number of most recent updates of a content directory service log;
computer code for updating a cache of the control point with updates from the web syndication feed as necessary;
computer code for determining if the oldest update in the web syndication feed is more recent than the time that the last synchronization occurred at the control point;
computer code for if the oldest update in the feed is more recent than the time that the last synchronization occurred at the control point, retrieving a next web syndication feed of updates;
computer code for continuing to retrieve subsequent web syndication feeds of updates until synchronization is complete at the control point; and
computer code for updating a value indicative of a last synchronization time.

18. The UPnP control point of claim 17, wherein the memory unit further comprises:
computer code for, before receiving the web syndication feed, receiving a request for authentication from the UPnP server; and
computer code for, in response to the request, providing credentials to the UPnP server for authentication.

19. The UPnP control point of claim 17, wherein the HTTP GET request is transmitted in response to a notification of changes in the content directory service received from the UPnP server.

20. The UPnP control point of claim 17, wherein the web syndication feed includes a URL to the predetermined number of most recent updates of the content directory service log.

21. The UPnP control point of claim 17, wherein the UPnP server comprises a UPnP AV server.

22. The UPnP control point of claim 17, wherein the web syndication feed comprises an ATOM feed.

23. A method for using a UPnP server to aid a UPnP control point in synchronizing content directory service metadata, comprising:
receiving a HTTP GET request of a log feed from the UPnP control point;
transmitting an web syndication feed including a predetermined number of most recent updates of the content directory service log;
after the UPnP control point has updated a cache of the control point with updates from the web syndication feed as necessary and determined that the oldest update in the web syndication feed is more recent than the time that the last synchronization occurred at the control point, transmitting a next web syndication feed of updates; and
continuing to transmit subsequent web syndication feeds of updates until synchronization is complete at the control point.

24. The method of claim 23, further comprising, before transmitting the web syndication feed:
transmitting a request for authentication to the UPnP control point; and
in response to the request, receiving credentials to the UPnP server for authentication.

25. The method of claim 23, wherein the HTTP GET request is received in response to a notification of changes in the content directory service transmitted to the UPnP control point.

26. The method of claim 23, wherein the web syndication feed includes a URL to the predetermined number of most recent updates of the content directory service log.

27. The method of claim 23, wherein the UPnP server comprises a UPnP AV server.

28. The method of claim 23, wherein the web syndication feed comprises an ATOM feed.

29. A computer program product, embodied in a computer-readable medium, for using a UPnP server to aid a UPnP control point in synchronizing content directory service metadata, comprising:
computer code for receiving a HTTP GET request of a log feed from the UPnP control point;
computer code for transmitting an web syndication feed including a predetermined number of most recent updates of the content directory service log;
computer code for, after the UPnP control point has updated a cache of the control point with updates from the web syndication feed as necessary and determined that the oldest update in the web syndication feed is more recent than the time that the last synchronization occurred at the control point, transmitting a next web syndication feed of updates; and
computer code for continuing to transmit subsequent web syndication feeds of updates until synchronization is complete at the control point.

30. The computer program product of claim 29, further comprising:
computer code for, before transmitting the web syndication feed, transmitting a request for authentication to the UPnP control point; and
computer code for, in response to the request, receiving credentials to the UPnP server for authentication.

31. The computer program product of claim 29, wherein the HTTP GET request is received in response to a notification of changes in the content directory service transmitted to the UPnP control point.

32. The computer program product of claim 29, wherein the web syndication feed includes a URL to the predetermined number of most recent updates of the content directory service log.

33. The computer program product of claim 29, wherein the UPnP server comprises a UPnP AV server.

34. The computer program product of claim 29, wherein the web syndication feed comprises an ATOM feed.

35. A UPnP server, comprising:
a processor; and
a memory unit operatively connected to the processor and including:
computer code for receiving a HTTP GET request of a log feed from a UPnP control point;
computer code for transmitting an web syndication feed including a predetermined number of most recent updates of a content directory service log;
computer code for, after the UPnP control point has updated a cache of the control point with updates from the web syndication feed as necessary and determined that the oldest update in the web syndication feed is more recent than the time that the last synchronization occurred at the control point, transmitting a next web syndication feed of updates; and
computer code for continuing to transmit subsequent web syndication feeds of updates until synchronization is complete at the control point.

36. The UPnP server of claim 35, wherein the memory unit further comprises:
computer code for, before transmitting the web syndication feed, transmitting a request for authentication to the UPnP control point; and
computer code for, in response to the request, receiving credentials to the UPnP server for authentication.

37. The UPnP server of claim 35, wherein the HTTP GET request is received in response to a notification of changes in the content directory service transmitted to the UPnP control point.

38. The UPnP server of claim 35, wherein the web syndication feed includes a URL to the predetermined number of most recent updates of the content directory service log.

39. The UPnP server of claim 35, wherein the UPnP server comprises a UPnP AV server.

40. The UPnP server of claim 35, wherein the web syndication feed comprises an ATOM feed.

41. A system for synchronizing content directory service metadata, comprising:
a UPnP control point; and
a UPnP AV server in at least selective communication with the UPnP control point,
wherein the UPnP control point is configured to:
transmit a HTTP GET request of a log feed to the UPnP AV server;
receive an ATOM feed including a predetermined number of most recent updates of a content directory service log;
update a cache of the control point with updates from the ATOM feed as necessary;
determine if the oldest update in the ATOM feed is more recent than the time that the last synchronization occurred at the control point;
if the oldest update in the feed is more recent than the time that the last synchronization occurred at the control point, retrieve a next ATOM feed of updates;
continue to retrieve subsequent ATOM feeds of updates until synchronization is complete at the control point; and
update a value indicative of a last synchronization time.
